(19) United States
(12) Patent Application Publication
(10) Pub. No.: US 2010/0238966 A1
(43) Pub. Date: Sep. 23, 2010

(54) LIGHT SOURCE APPARATUS AND PROJECTOR

(75) Inventor: Masamitsu MOCHIZUKI, Suwa-gun (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/720,991

(22) Filed: Mar. 10, 2010

(30) Foreign Application Priority Data
Mar. 17, 2009 (JP) 2009-064366

(51) Int. Cl. H01S 3/08

(52) U.S. Cl. 372/99; 372/102

(57) ABSTRACT

A light source apparatus includes: a light emitter; a pair of electrodes for driving the light emitter; and an external resonant cavity that reflects part of the light emitted from a light-exiting end surface of the light emitter. The light emitter includes an active layer that generates light, an internal resonant cavity, and a diffractive optical layer that diffracts light having a predetermined wavelength. The external resonant cavity includes an external mirror that reflects the light having the predetermined wavelength. The internal resonant cavity, the external resonant cavity, and the diffractive optical layer form a laser resonant cavity that allows the light generated in the active layer to achieve laser oscillation.

### BACKGROUND

1. Technical Field

The present invention relate to a light source apparatus and a projector.

2. Related Art

In a field of projectors and other similar optical apparatus, a high-pressure mercury lamp has been extensively used as an illumination light source. An advantage of a high-pressure mercury lamp includes high intensity of the emitted light, but disadvantages thereof include limited color reproducibility, difficulty of quick start and shut off, and a short life. Under such circumstances, there have been expectations for laser light source apparatus using a semiconductor laser or any other suitable solid-state light source instead of a high-pressure mercury lamp. JP-A-5-48200 and U.S. Pat. No. 6,404,797 disclose exemplary semiconductor laser devices.

The external-cavity wavelength-tunable semiconductor laser apparatus disclosed in JP-A-5-48200 includes a Fabry-Perot resonator-based semiconductor laser device (light emitter) and a collector lens disposed between the light emitter and an external reflection mirror. The light emitted from the light emitter is collected through the collector lens and incident on the external reflection mirror, and the light reflected off the external reflection mirror is also collected by the collector lens and incident on (fed back to) the light emitter. The light propagates back and forth between the light emitter and the resonant mirror, whereby resonance and hence laser oscillation occur.

The laser light source apparatus disclosed in U.S. Pat. No. 6,404,797 has an electrode, a semiconductor substrate, a first reflector, a quantum well, and a second reflector provided in this order. The substrate is disposed to face upward, and the annular electrode is provided on the rear side of the substrate. The light emitted by current injection from the quantum well toward the first reflector (upward) is collected through a thermal lens formed by Joule heat produced in the substrate. Then the light is reflected back off an external reflection mirror disposed at the focal point of the thermal lens. The light reflected back off the external reflection mirror is collected through the thermal lens again, passes through the first reflector, returns to the quantum well, and is reflected back again off the second reflector. The light propagates back and forth between the external mirror and the second reflector, whereby resonance and hence laser oscillation occur.

The laser light source apparatus disclosed in JP-A-5-48200 and U.S. Pat. No. 6,404,797 may conceivably achieve laser oscillation and provide high-intensity laser light, but some portions should be improved not only to reduce the cost of the apparatus but also to increase the output intensity.

To increase the output intensity, it is important to achieve satisfactory laser oscillation. To this end, aligning the light flux along the forward path the light flux along the return path in the resonant cavity so that they precisely coincide with each other is an effective approach. In the laser light source apparatus disclosed in JP-A-5-48200, however, the configuration in which the collector lens is separate from the light emitter makes it difficult to improve the positional precision of the collector lens relative to the light emitter and the positional precision of the collector lens relative to the external reflection mirror. Alignment based on an XY stage or any other similar positioning apparatus is limited in terms of precision because improvement in positional precision results in increase in alignment cost.

When the collector lens is integrated with the light emitter, as in U.S. Pat. No. 6,404,797, no separate collector lens is necessary, and it is therefore conceivable that the alignment precision in directions perpendicular to the optical axis (X and Y directions) can be improved significantly. On the other hand, the focal length and other characteristics of the thermal lens are sensitive to the amount and distribution of the current flowing through the thermal lens, and it is therefore difficult to achieve a stable operation of the thermal lens. When the focal length of the thermal lens varies, the distribution of the light reflected back off the external mirror disadvantageously differs from that of the emitted light and the diameter of the reflected light becomes large compared to that of the emitted light. As a result, only part of the return light reaches the second reflector and contributes to resonance. That is, increase in coupling loss disadvantageously increases the resonant cavity loss, resulting in a reduced output intensity of the laser light.

### SUMMARY

An advantage of some aspects of the invention is to provide a light source apparatus capable of not only increasing the output intensity from the apparatus but also reducing the cost thereof. Another advantage of some aspects of the invention is to provide a projector capable of providing a high-quality projection image.

A light source apparatus according to a first aspect of the invention includes a light emitter, a pair of electrodes for driving the light emitter, and an external resonant cavity that reflects part of the light emitted from a light-exiting end surface of the light emitter. The light emitter includes an active layer that generates light, an internal resonant cavity, and a diffractive optical layer that diffracts light having a predetermined wavelength. The external resonant cavity includes an external mirror that reflects the light having the predetermined wavelength. The internal resonant cavity, the external resonant cavity, and the diffractive optical layer form a laser resonant cavity that allows the light generated in the active layer to achieve laser oscillation.

In this way, when the light generated in the active layer resonates in the internal resonant cavity, phase matching of the light is achieved by the diffractive optical layer just below a threshold at which laser oscillation occurs. Part of the phase-matched light, light having the predetermined wavelength (hereinafter sometimes referred to as a fundamental wavelength), is diffracted by the diffractive optical layer and exits through the light-exiting end surface of the light emitter. The direction of the optical axis of the diffracted light changes in accordance with the wavelength thereof, and part of the light having fundamental wavelength is diffracted toward the external mirror. Then the light exited from the light emitter and having the fundamental wavelength is reflected back off the external mirror and fed back to the light emitter and the internal resonant cavity. The light generated in the active layer and having the fundamental wavelength not only resonates in the internal resonant cavity but also resonates in the external cavity in a process that the light is diffracted by the diffractive optical layer toward the external mirror and fed back from the external mirror to the light emitter. When the externally resonating light returns to the active layer, the light that has not received sufficient gain only in the internal resonant cavity receives sufficient gain for laser oscillation. Laser light having the fundamental wavelength is thus provided.

Since the laser oscillation occurs in the laser resonant cavity including the internal resonant cavity and the external resonant cavity, the resonant cavity length can be readily increased as compared with a case where laser oscillation occurs only in the internal resonant cavity. It is therefore possible to insert a device that is effective as becoming large, such as a nonlinear device, in a high electric field strength area in the laser resonant cavity. Further, since no laser oscillation occurs only by the internal resonance, imparting wavelength selectivity to the external mirror prevents the number of oscillation modes from increasing in the internal resonant cavity alone even when a current injection area of the internal resonant cavity is enlarged. It is therefore possible to provide high-intensity laser light even when the number of oscillation modes is small.

Further, the configuration described above in which the light generates in the active layer resonates in the internal resonant cavity to the extent that no laser oscillation occurs and is phase-matched by the diffractive optical layer improves the degree of parallelism of the light emitted from the light emitter. As a result, no collector lens is necessary between the light emitter and the external mirror, whereby the number of parts can be reduced as compared with a case where a collector lens is used. It is therefore possible to reduce alignment cost and apparatus cost.

Since the parallelism of the light emitted from the light emitter can be improved, no thermal lens is necessary in the light emitter. Using no thermal lens significantly reduces variation in diffusion angle of the light emitted from the light emitter, whereby the laser oscillation occurs in a stable manner. Further, the distance between the active layer and the electrode on the side where the light-exiting end surface is present can be reduced as compared with a case where a thermal lens is used, whereby the electric resistance can be reduced. It is therefore possible to reduce power consumption and improve temperature characteristics.

The aspect of the invention described above thus provides a light source apparatus that can achieve cost reduction and emit high-intensity laser light at high efficiency.

The diffractive optical layer is preferably made of a photonic crystal or a quasi-photonic crystal.

When the diffractive optical layer is made of a photonic crystal or a photonic quasi-crystal, the diffractive optical layer can be designed to show desired characteristics, that is, the angle of diffraction, the spectral bandwidth, and other parameters of the light that exits through the diffractive optical layer can be precisely controlled to be desired values. Further, using a diffractive optical layer made of a photonic crystal allows part of the incident light having the fundamental wavelength to be diffracted not only in the direction perpendicular to the light-exiting end surface but also in the direction parallel thereto. In this way, the diffractive optical layer can serve not only as a resonant mirror of a coupling optical system between the diffractive optical layer and the external mirror but also as the resonant mirrors of the internal resonant cavity. It is therefore possible to simplify the configuration of the apparatus, improve the light usage efficiency, and reduce the cost of the apparatus.

The diffractive optical layer preferably diffracts part of the light having the predetermined wavelength in such a way that the part of the light having the predetermined wavelength is incident on the reflection surface of the external mirror in the direction of a normal thereto.

In this way, an external resonant cavity can be formed between the diffractive optical layer and the external mirror without any collector lens or other similar components.

It is preferred that the reflection surface of the external mirror is substantially parallel to the light-exiting end surface, and that the diffractive optical layer diffracts part of the light having the predetermined wavelength in the direction perpendicular to the light-exiting end surface.

In this way, an external resonant cavity can be formed between the diffractive optical layer and the external mirror without any thermal lens or other collector lenses.

The diffractive optical layer preferably diffracts part of the light having the predetermined wavelength in the direction parallel to the light-exiting end surface.

In this way, the diffractive optical layer can be the resonant mirrors of the internal resonant cavity.

The external mirror may be formed of a volume holographic grating.

A volume holographic grating (hereinafter sometimes referred to as VHG) can desirably set the wavelength of the light reflected off the VHG and spectral bandwidth of which with high selectivity. By using this property, for example, the number of oscillation modes can be reduced so that external resonance occurs only in a specific mode in a reflection bandwidth of the VHG.

The external mirror may be formed of a fiber grating.

A fiber grating (hereinafter sometimes referred to as FBG) can readily control the output direction of the light produced by laser oscillation.

The light emitter preferably has a current constriction region that limits an area across which carriers are injected from the pair of electrodes in a in-plane direction parallel to the active layer.

In this way, the current constriction region limits the carrier injection area in the in-plane direction at the active layer, whereby the density of the carriers supplied to the part of active layer can be increased. It is therefore possible to define the area of the active layer in which light is generates and efficiently produce high-intensity light from the active layer.

The light emitter preferably includes a heat spreading member on the side opposite the light-exiting end surface.

In this way, the heat generated in the light emitter can be spread through the heat spreading member, whereby the light source apparatus can provide high-intensity light in a stable manner.

The light source apparatus may further include a wire grid optical polarizer in the optical path between the light emitter and the external mirror, the wire grid optical polarizer carrying out an optical polarization separation process in which the light emitted from the light emitter is separated based on optical polarization, and the wire grid optical polarizer may be provided monolithically with the light emitter.

The light source apparatus can further include a wavelength conversion device in the optical path between the light emitter and the external resonant cavity. In this case, the wavelength conversion device preferably has a periodically poled structure.

When the light source apparatus includes a wavelength conversion device, light having a wavelength that cannot be obtained directly from the light emitter can be extracted, and high-intensity light having a desired wavelength is provided. Further, according to a wavelength conversion device having a periodically poled structure, such as PPLN (periodically poled lithium niobate), the light having the fundamental wavelength can be converted into light having the converted wavelength at high efficiency with high precision.

When the wire grid optical polarizer is provided, the polarization direction of the light separated by the wire grid optical polarizer and incident on the wavelength conversion device is polarized is preferably substantially parallel to the direction of the electrically polarized axis of the wavelength conversion device.

In this way, the polarization direction of the light incident on the wavelength conversion device coincides with the wavelength conversion device can converted polarization direction that the wavelength of the light most efficiently.

When the wire grid optical polarizer is provided, one of the pair of electrodes may be formed by the wire grid optical polarizer itself.

Since no thermal lens is necessary in the invention, the path along which the carriers are supplied to the active layer is not limited, and thus one of the electrodes can be formed of the wire grid optical polarizer. It is therefore possible to reduce the number of parts and hence reduce the cost of the light source apparatus, as compared with a case where the wire grid optical polarizer is provided separately from the light emitter.

A projector according to a second aspect of the invention includes any of the light source apparatus based on the first aspect of the invention described above, a modulator that modulates the light emitted from the light source apparatus, and a display system that displays the light modulated by the modulator.

Since any of the light source apparatus based on the first aspect of the invention produces high-intensity light, the high-intensity light is modulated by the modulator and then displayed through the display system. An image displayed by the projector therefore has high brightness, a large dynamic range, and high quality. Further, the light source apparatus can be manufactured at a lower cost than a case where a lamp-based light source, for example, using a discharge arc tube is used, and a color separation system, an optical polarization device, and other components can be simplified or omitted. The apparatus cost of the projector can therefore be reduced. Further, when a light valve or any other spatial modulator is used as the modulator of the projector of the invention, a collimator lens or any other similar component through which light incidents on the spatial modulator can be simplified or omitted, whereby the apparatus cost of the projector can be reduced.

### BRIEF DESCRIPTION OF THE DRAWINGS

The invention will now be described with reference to the accompanying drawings, wherein like numbers refer to like elements.

FIG. 1 is a perspective view showing a schematic configuration of a light source apparatus according to a first embodiment.

FIG. 2A is an enlarged view of a light emitter, and FIG. 2B is a cross-sectional view of a key portion shown in FIG. 2A.

FIG. 3 is a plan view showing a two-dimensional photonic crystal structure in the first embodiment.

FIGS. 4A to 4D are plan views showing exemplary lattice arrangements.

FIGS. 5A and 5B are plan views showing other exemplary lattice arrangements.

FIG. 6 is a descriptive diagram showing the mechanism according to which laser oscillation occurs in the first embodiment.

FIG. 7 is a perspective view showing a schematic configuration of a light source apparatus according to a second embodiment.

FIG. 8 is a cross-sectional view of a key portion of a light emitter in the second embodiment.

FIG. 9 is a descriptive diagram showing the mechanism according to which laser oscillation occurs in the second embodiment.

FIG. 10 is a perspective view showing a schematic configuration of a light source apparatus according to Variation 1.

FIGS. 11A to 11F are cross-sectional views of a key portion showing schematic configurations of diffractive optical layers according to Variations 2 to 7.

FIGS. 12A to 12C are process diagrams showing an exemplary method for manufacturing a light source apparatus.

FIGS. 13A and 13B are process diagrams following that of FIG. 12C.

FIG. 14 is a diagrammatic view showing a schematic configuration of an embodiment of a projector.

### DESCRIPTION OF EXEMPLARY EMBODIMENTS

Embodiments of the invention will be described below. It is, however, noted that the technical scope of the invention is not limited to the following embodiments. In the following description, a variety of structures are illustrated with reference to the drawings, and it is noted that the structures in the drawings may differ from the actual structures in terms of dimension and scale in order to clarify structurally characteristic portions.

### First Embodiment

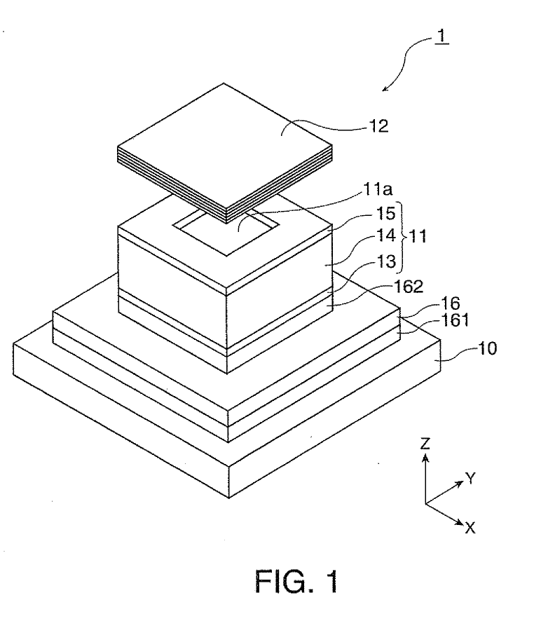

FIG. 1 is a perspective view showing a schematic configuration of a light source apparatus 1 according to a first embodiment. As shown in FIG. 1, the light source apparatus 1 includes a heat sink (heat spreading member) 10, a light emitter 11, and an external mirror 12. The heat sink 10 in the present embodiment is a plate-shaped member. The direction normal to one side of the heat sink 10 is the direction of a principal optical axis of the light source apparatus 1. The light emitter 11 and the external mirror 12 are disposed in this order in the direction of the principal optical axis of the light source apparatus 1 from the heat sink 10. In the present embodiment, each of the light emitter 11 and the external mirror 12 has a substantially oblong shape when viewed from the above (a substantially square shape in FIG. 1).

In the following description, the positional relationship of the members will be described based on the XYZ orthogonal coordinate system set and shown in FIG. 1. In the XYZ orthogonal coordinate system, let the Z direction be the direction of the principal optical axis of the light source apparatus 1, the X direction be the direction along with one of the two orthogonal sides of the light emitter 11 when viewed from the above, and the Y direction be the direction along with the other of the two orthogonal sides.

The heat sink 10 is made of a material that has high heat conductivity. Examples of the high heat conductive material include DLC (diamond-like carbon), BeO, Au, Ag, Cu, and Sn. The heat sink 10 in the present embodiment is made of Cu and has a thickness ranging from approximately several hundreds of micrometers to millimeter.

A sub-mount 16 is provided between the heat sink 10 and the light emitter 11. The sub-mount 16 is bonded to the heat sink 10 with an adhesive 161. The light emitter is bonded to the sub-mount 16 with an adhesive 162.

The sub-mount 16 is, for example, a plate-shaped member having a thickness ranging from approximately several micrometers to several tens of micrometers. Each of the adhesives 161 and 162 is made of solder containing AuSn, SnAgCu, or any other suitable material, or silver paste or any other suitable adhesive and has a thickness ranging from approximately several micrometers to several tens of micrometers.

The light emitter 11 has a structure formed of a pair of electrodes, a first electrode 13 and a second electrode 15, and a semiconductor layer 14 sandwiched therebetween. In the present embodiment, each of the first electrode 13 and the second electrode 15 is formed of a metal film substantially parallel to the plane (XY plane) across which the heat sink 10 extends. The position of the first electrode 13 is closer to the heat sink 10 than that of the second electrode 15 and functions as a reflective mirror. The second electrode 15 is provided in such a way that part of the surface of the semiconductor layer 14 that is perpendicular to the direction of the principal optical axis (Z direction) is exposed. In the present embodiment, the surface of the semiconductor layer 14 that is not covered by the second electrode 15 is a light-exiting end surface 11a of the light emitter 11, and light having a fundamental wavelength exits through the light-exiting end surface 11a in the direction of the principal optical axis. Phase-matched light that resonates to the extent that no laser oscillation occurs without external mirror 12 is emitted from the light emitter 11, the details of which will be described later.

The external mirror 12 in the present embodiment is formed of a plate-shaped dielectric mirror composed of a dielectric multilayer film and having a thickness ranging from approximately several micrometers to several hundreds of micrometers. The surface of the external mirror 12 on which the light emitted from the light emitter 11 is incident is substantially perpendicular to the optical axis of the incident light. The external mirror 12 has wavelength selectivity and reflects back only the light having the fundamental wavelength.

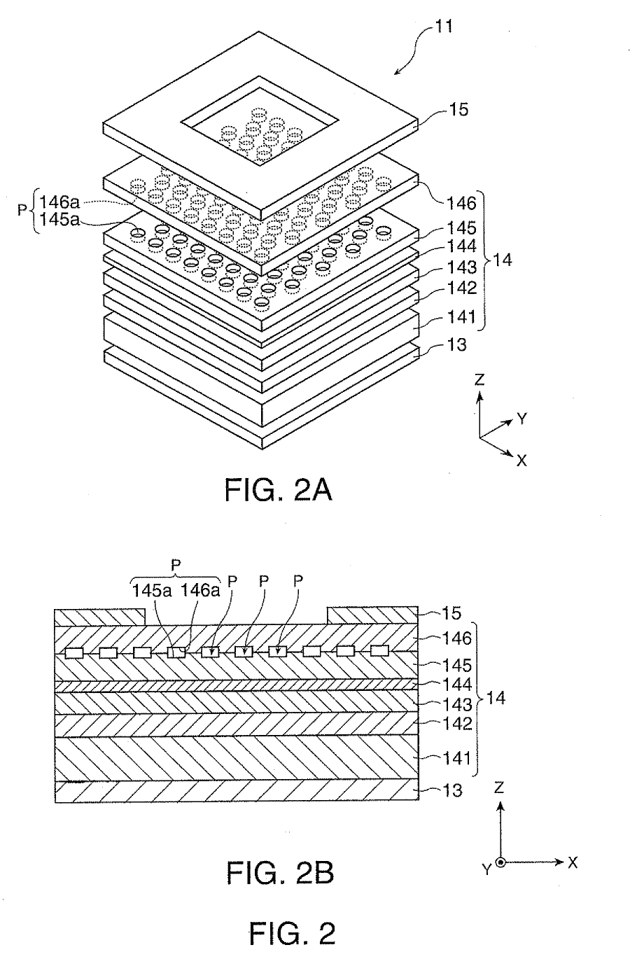

FIG. 2A is an enlarged, exploded perspective view of the light emitter 11, and FIG. 2B is a cross-sectional view of the light emitter 11 taken along the direction of the principal optical axis. As shown in FIGS. 2A and 2B, the semiconductor layer 14 has a structure in which a semiconductor substrate 141, an n-cladding layer 142, a first guiding layer 143, a multi-quantum well layer (MQW) 144, a second guiding layer 145, and a p-cladding layer 146 are stacked in this order between the first electrode 13 and the second electrode 15 in the direction from the first electrode 13 toward the second electrode 15. In the present embodiment, the MQW 144 functions as an active layer, and the second guiding layer 145 and the p-cladding layer 146 function as not only guiding or cladding layer but also a diffractive optical layer when a photonic crystal or quasi-photonic crystal structure is introduced on it. Only of the p-cladding layer 146, or the n-cladding layer or the first guiding layer, or the p-cladding layer and the n-cladding layer may function as a diffractive optical layer when a photonic crystal or quasi-photonic crystal structure is introduced on it, as well.

The semiconductor substrate 141 is, for example, made of GaAs and has a thickness ranging from approximately 50 to 500 micrometers. The n-cladding layer 142 is, for example, made of Al_{0.9}Ga_{0.1}As and has a thickness ranging from approximately 0.5 to several micrometers. The first guiding layer 143 is, for example, made of Al_{0.5}Ga_{0.5}As and has a thickness ranging from approximately several tens of nanometers to several hundreds of nanometers. The MQW 144 has a periodic structure of, for example, GaAs/Al_{0.3}Ga_{0.7}As and includes 1 to 7 wells, each having a thickness of approximately several nanometers. The second guiding layer 145 is, for example, made of Al_{0.5}Ga_{0.5}As and has a thickness ranging from several tens of nanometers to several hundreds of nanometers. The p-cladding layer 146 is made, for example, of Al_{0.9}Ga_{0.1}As and has a thickness ranging from approximately 0.5 to several micrometers.

The material, thickness, type, and other parameters of each of the layers that form the semiconductor layer are not limited to those described in the above example, and can be appropriately designed in accordance with, for example, the wavelength of the light emitted from the light emitter. For example, it is contemplated in a second embodiment that second harmonic waves obtained from a wavelength conversion device are used as the output light extracted outward, and that the wavelength of the light emitted from the light emitter is twice a wavelength of the visible range, that is, a wavelength in the infrared band.

A large number of recesses 145a are provided in the second guiding layer 145 and periodically arranged in a plane parallel thereto. Similarly, a large number of recesses 146a are provided in the p-cladding layer 146 and periodically arranged in a plane parallel thereto. Each of the recesses 145a and 146a has a substantially circular shape when viewed from the above, and an entire single recess 145a and an entire single recess 146a are overlaid with each other when viewed from the above. A pair of recesses 145a and 146a forms a single lattice point P in the diffractive optical layer. The total depth of a pair of recesses 145a and 146a (the depth of a lattice point P) ranges, for example, from approximately several tens of nanometers to several hundreds of nanometers.

The refractive index of the diffractive optical layer in the present embodiment periodically varies in the plane (X and Y directions) perpendicular to the direction of the principal optical axis (Z direction), because a large number of lattice points P are, for example, periodically arranged. That is, the diffractive optical layer is formed of a photonic crystal. The light incident on the diffractive optical layer is diffracted and directed in a direction according to the wavelength of the incident light. The lattice constant of the photonic crystal and other parameters can be, in general, calculated by analyzing the photonic band structure.

The diffractive optical layer may alternatively be compressed of a circular grating with concentric grooves formed therein. In this case, an approximate relationship indicated by the following equation (1) is established:

2d(1−cos θ)=mλ/n_{eff} (1)

where d [m] is the distance between the grooves, θ [rad] is the diffraction angle with reference to the diffractive optical layer, n_{eff} is the effective refractive index of the diffractive optical layer, λ [m] is the fundamental wavelength, and m is an integer. The effective refractive index n_{eff} is a value determined by the material of the diffractive optical layer, the depth of each groove, the distance between the grooves, and other parameters.

For example, when the distance d between the grooves in a circular grating is set to λ/(2n_{eff}), the equation (1) is rewritten as the following equation (2):

1−cos θ=m (2)

That is, the zeroth-order (m=0) diffraction occurs in the direction θ=0°, the first-order (m=1) diffraction occurs in the direction θ=90°, and the second-order (m=2) diffraction occurs in the direction θ=180°, (so that the equation (2) is satisfied). That is, the diffraction that occurs in the direction θ=0° or 180° (direction parallel to the light-exiting surface) forms the resonant mirrors of an internal resonant cavity for the light having the fundamental wavelength, and the diffraction that occurs in the diffractive optical layer in the directions θ=90° (directions perpendicular to the light-exiting surface) allows the light having the fundamental wavelength to be coupled with the external mirror.

The conditions described above can be realized not only for a circular grating but also for a photonic crystal or other suitable structures when analyzing the photonic band structure or the like.

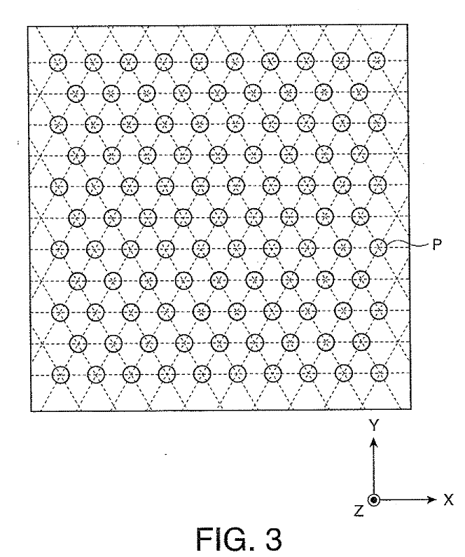

FIG. 3 is a plan view showing the arrangement of photonic crystal lattices in the present embodiment. As shown in FIG. 3, the lattice points P are arranged in a triangular lattice structure in the present embodiment. Specifically, the lattice points P are arranged along the X direction to form rows, which are then arranged in the Y direction. Looking at two rows arranged in the Y direction, one can see that the lattice points P in one row is shifted in terms of phase from those in the other row by one-half the distance between the lattice points P, and that the lattice points P are disposed in a staggered triangular lattice. Two lattice points disposed adjacent to each other in the X direction in one row and the lattice point P disposed between the two lattice points in the other row are arranged in such a way that the three lattice points P coincide with the apexes of the corresponding equilateral triangle.

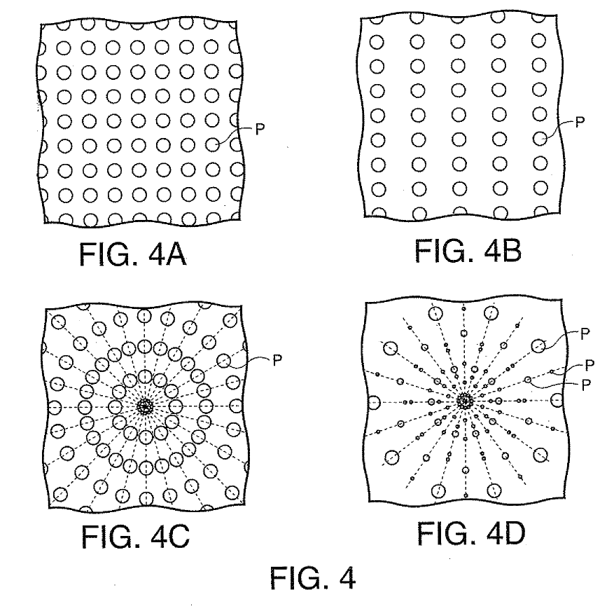

Instead of the lattice arrangement shown in FIG. 3, any of the lattice arrangements shown in FIGS. 4A to 4D may be used in the diffractive optical layer.

In the lattice arrangement shown in FIG. 4A, the lattice points P are arranged in a square lattice. The lattice points P are arranged not only at equal distances in the X direction but also at equal distances in the Y direction. The lattice constant of the X direction substantially coincide with the lattice constant of the Y direction.

In the lattice arrangement shown in FIG. 4B, the lattice points P are arranged in an oblong lattice. The lattice points P are arranged not only at equal distances in the X direction but also at equal distances in the Y direction. The lattice constant of the X direction differ from the lattice constant of the Y direction. In the above lattice arrangement, the diffraction efficiency of the oscillating light in the diffractive optical layer is different depending on the X or Y directions. In the present invention, the difference in diffractive efficiency includes the difference in the amplitude of the electro-magnetic field. It is therefore possible to control the polarization direction of the emitted light in a desired direction.

In the lattice arrangement shown in FIG. 4C, the lattice points P are periodically disposed not only around the axis of rotation but also in the radial directions.

A honeycomb lattice using apexes of hexagons or any other suitable lattice may be used instead of the triangular and rectangular lattices (the square and oblong lattices) described above.

Like a penrose lattice shown in FIG. 4D, a quasi-photonic crystal in which the dimension of each lattice changes in the translation direction may be used in the diffractive optical layer.

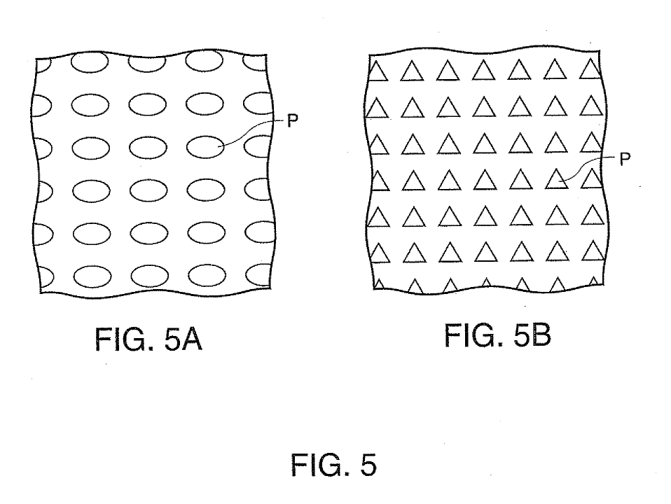

FIGS. 5A and 5B are plan views showing exemplary lattice shapes different from that in the present embodiment. When using lattices having a substantially elliptical shape in a plan view shown in FIG. 5A, the diffraction efficiency of the light oscillating in the diffractive optical layer is different depending on the directions along with major or minor axis of the ellipse. It is therefore possible to control the polarization direction of the emitted light in a desired direction.

Using lattice points having a substantially triangular shape in a plan view shown in FIG. 5B allows the diffraction efficiency to increase, as compared with those in the case where the shape of the lattice points in a plan view is substantially circular or elliptical. Further, the diffractive optical layer in this case has not only a band gap for light polarized in TE direction which electric field oscillates in the direction parallel to the light-exiting surface but also a band gap for light polarized in TM direction which electric field oscillates only in the direction perpendicular to the light-exiting surface (the magnetic field oscillates in the direction parallel to the light-exiting surface). As a result, in the diffractive optical layer, the resonant mirrors of the internal resonant cavity can show high light usage efficiency.

Whenever any of the lattice arrangements and the lattice shapes described above are employed, the relationship between the diffraction angle and the wavelength is exactly determined, for example, by carrying out a numerical simulation, and the diffractive optical layer can be designed based on the relationship. In the present embodiment, the diffractive optical layer is designed in such a way that the first-order diffracted light of the light having the fundamental wavelength is diffracted at a diffraction angle of approximately 90° and the second-order diffracted light is diffracted at a diffraction angle of 180°, as described above.

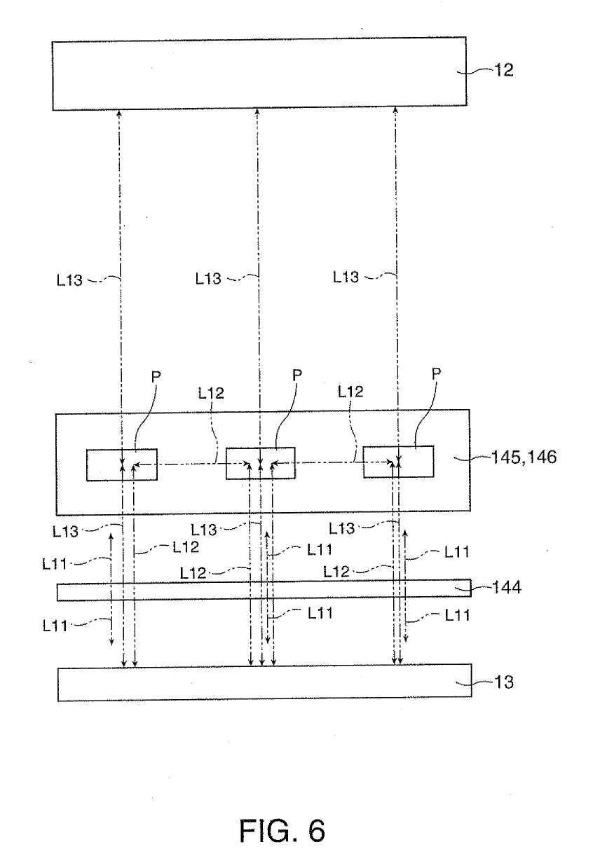

FIG. 6 is a descriptive diagram schematically showing the mechanism according to which laser oscillation occurs in the light source apparatus 1.

When a voltage is applied between the first electrode 13 and the second electrode 15 shown in FIG. 2B, the MQW 144 emits light L11 having the fundamental wavelength, as shown in FIG. 6. The light L11 is, for example, infrared light having a spectral bandwidth of approximately several tens of nanometers. The light L11 generated by the MQW 144 in the direction perpendicular to the light-exiting end surface and directed toward the first electrode 13 is reflected back off the first electrode 13. The light L11 then propagates toward the diffractive optical layers 145 and 146 in the direction perpendicular to the light-exiting end surface. The light L11 generated by the MQW 144 in the direction perpendicular to the light-exiting end surface and directed toward the diffractive optical layers 145 and 146 as well as the light L11 reflected back off the first electrode 13 are incident on the diffractive optical layers 145 and 146.

Part of the light incident on the diffractive optical layers 145 and 146 is diffracted by the diffractive optical layers 145 and 146 and directed in the direction of 0°, 90′, or 180°. Part of light L12 diffracted by the diffractive optical layers 145 and 146 and directed in the direction of 0° or 180° resonates in a process in which the light propagates back and forth multiple times in the diffractive optical layers 145 and 146 in parallel to the light-exiting end surface. Another part of the light L12 propagating in the diffractive optical layers 145 and 146 in the direction parallel to the light-exiting end surface is diffracted by the diffractive optical layers 145 and 146 in the direction perpendicular to the light-exiting end surface and propagates back and forth multiple times between the first electrode 13 and the diffractive optical layers 145 and 146. That is, the diffractive optical layers 145 and 146 and the space between the diffractive optical layers 145, 146 and the first electrode 13 are internal resonant cavities in the present embodiment.

In the invention, the internal resonant cavities are designed in such a way that the light L11 is phase-matched to the extent that no laser oscillation occurs. An exemplary, method for designing such an internal resonant cavity described above is tentatively designing an internal resonant cavity capable of achieving laser oscillation and then shifting design parameters from the design values. Specific exemplary methods for shifting design parameters from the design values may be reducing the depth of each lattice point P in the diffractive optical layers 145 and 146, increasing the distance between lattice points P in the diffractive optical layers 145, 146 and the MQW 144, and reducing the period of the lattice points P. Any of the methods described above or a combination of two or more of the methods described above can be used to reduce the diffraction efficiency so that no laser oscillation occurs.

Part of the light L12 having resonated and having been phase-matched in the corresponding internal resonant cavity is also diffracted by the diffractive optical layers 145, 146 in the direction of 90°, that is, vertically upward and downward with respect to the light-exiting end surface. Light L13 diffracted vertically upward and downward with respect to the light-exiting end surface has a significantly small diffusion angle because it has a single wavelength and phase; the light diffracted vertically upward is incident on the external mirror 12 as a substantially parallelized light, whereas the light diffracted vertically downward is incident on the first electrode 13 as substantially parallelized light.

As shown in FIG. 6, the light L13 having the fundamental wavelength and incident on the external mirror 12 is reflected back off the external mirror 12 and then incident on the diffractive optical layers 145, 146. Due to the zeroth-order and second-order diffraction, part of the incident light is coupled with the internally resonating light L12, whereas the other part of the incident light passes through the diffractive optical layers 145, 146 and is incident on the first electrode 13. Similarly, the light L13 having the fundamental wavelength and incident on the first electrode 13 is reflected back off the first electrode 13 and then incident on the diffractive optical layers 145, 146. Due to the zeroth-order and second-order diffraction, part of the incident light is coupled with the internally resonating light L12, whereas the other part of the incident light passes through the diffractive optical layers 145, 146 and is incident on the external mirror 12.

In this way, due to the diffraction, the light L12 having been phase-matched in the process in which it propagates back and forth multiple times in the internal resonant cavity formed of the diffractive optical layers in the direction parallel to the light-exiting end surface couples with the light L13 that propagates back and forth multiple times in the resonant cavity formed between the first electrode 13 and the external mirror 12. As a result, the light L12 having resonated but achieved no laser oscillation only in the corresponding internal resonant cavity can be sufficiently amplified after it experiences the external resonance and returns to the internal resonant cavity. Laser oscillation thus occurs. Part of the resultant laser light, that is, part of the light L13, passes through the external mirror 12 and exits out of the light source apparatus 1.

According to the light source apparatus 1 described above, the light having the fundamental wavelength and having a single phase and wavelength achieved in the internal resonant cavities is diffracted by the diffractive optical layers 145, 146 and emitted from the light emitter 11. The light emitted from the light emitter 11 is therefore substantially parallelized light having an optical axis precisely defined in a certain direction and a significantly small divergence angle. The light emitted from the light emitter 11 can therefore be incident on the external mirror 12 at a certain angle with precision without any collector lens, a thermal lens, or other lenses, and the light can be precisely fed back toward the light emitter 11. In the thus configured light source apparatus, the light emitted from the light emitter 11 has satisfactory achieved laser oscillation and is high-intensity laser light.

In the light source apparatus 1 according to the first embodiment, the necessity of using a collector lens decreases from the viewpoint of configuring a resonant cavity. Omitting a thermal lens or any other collector lens can reduce the number of parts and alignment cost. Further, the laser oscillation stably occurs because no thermal lens is necessary.

As described above, the light source apparatus 1 according to the first embodiment allows cost reduction and provides high-intensity laser light. Further, imparting wavelength selectivity to the external mirror allows the number of oscillation modes to be reduced while maintaining the high-intensity output, and thus laser oscillation in a specific mode can also be possible.

### Second Embodiment

A light source apparatus according to a second embodiment will be described. The second embodiment differs from the first embodiment in terms of the following points: The second electrode of the light emitter is formed of a wire grid optical polarizer. The external mirror is formed of a VHG. A wavelength conversion device is provided between the light emitter and the external mirror.

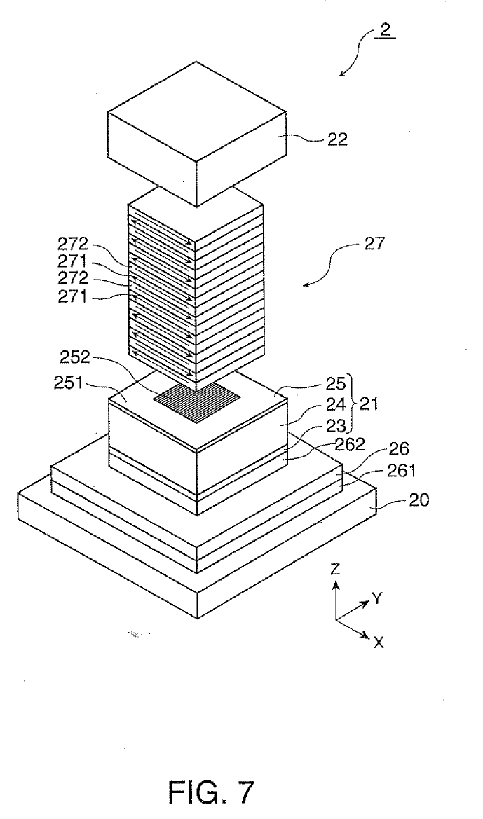

FIG. 7 is a perspective view showing a schematic configuration of a light source apparatus 2 according to the second embodiment. As shown in FIG. 7, the light source apparatus 2 includes a heat sink 20, a light emitter 21, and an external mirror 22. The direction perpendicular to the plane (XY plane) across which the heat sink 10 extends is the direction of the principal optical axis of the light emitter 21. The heat sink 20, the light emitter 21, the wavelength conversion device 27, and the external mirror 22 are disposed in this order in the direction of the principal optical axis, as in the first embodiment.

A sub-mount 26 is provided between the heat sink 20 and the light emitter 21. The sub-mount 26 is bonded to the heat sink 20 with an adhesive 261. The light emitter is bonded to the sub-mount 26 with an adhesive 262. The heat sink 20, the sub-mount 26, and the adhesives 261, 262 are the same as those in the first embodiment.

The light emitter 21 has a structure formed of a pair of electrodes, a first electrode 23 and a second electrode 25, and a semiconductor layer 24 sandwiched therebetween. The first electrode 23 is bonded to the sub-mount 26 via the adhesive 262 and functions as a reflective mirror, as in the first embodiment.

The second electrode 25 has a substantially plate-like shape and is formed of a frame 251 and a wire grid 252. The wire grid 252 is formed of a large number of fine metal wires provided in the portion surrounded by the frame 251, and the level of the wires is flush with the frame 251. The large number of fine metal wires are parallel to each other and extend in the Y direction in the present embodiment.

When the light incidents on the thus configured wire grid 252, the light component polarized in the direction that the fine metal wires extend (Y direction) is reflected by the wire grid 252, whereas the light component polarized in the direction perpendicular to the direction that the fine metal wires extend (X direction) passes through the wire grid 252.

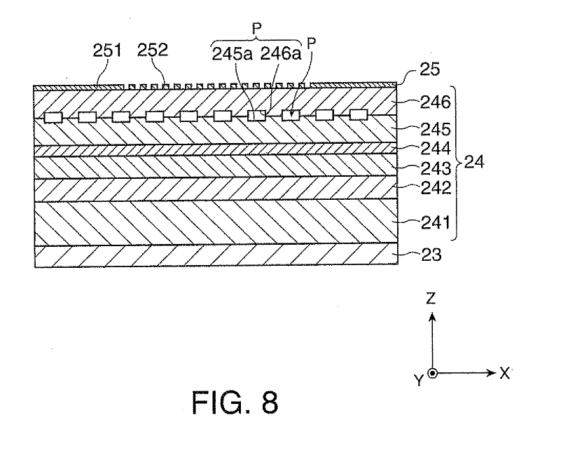

FIG. 8 is a cross-sectional view of the light emitter 21 taken along the direction of the principal optical axis. As shown in FIG. 8, the configuration of the semiconductor layer 24 is the same as that in the first embodiment. That is, the semiconductor layer 24 has a structure in which a semiconductor substrate 241, an n-cladding layer 242, a first guiding layer 243, an MQW 244, a second guiding layer 245, and a p-cladding layer 246 are stacked in this order between the first electrode 23 and the second electrode 25 in the direction from the first electrode 23 toward the second electrode 25. Recesses 245a provided in the second guiding layer 245 and recesses 246a provided in the p-cladding layer 246 form lattice points P.

The wavelength conversion device 27 shown in FIG. 7 produces second harmonic waves and converts at least part of the incident light into light having a wavelength substantially one-half the wavelength of the incident light. The wavelength conversion device 27 in the present embodiment is made of PPLN and has a periodic structure in which electrically poled sections 271 and reversely poled sections 272 are alternately arranged. One direction perpendicular to the periodic direction is the direction of the electrically poled axis. The wavelength conversion device 27 converts the wavelength of the light propagating along the periodic direction. The conversion efficiency is particularly high when the polarization direction of the light coincident with the direction of the electrically poled axis. The wavelength conversion efficiency can become high when the dimension in the periodic direction is increased. The wavelength conversion device 27 is disposed in such a way that the periodic direction coincides with the direction of the principal optical axis of the light emitter 21, and that the direction of the electrically poled axis is perpendicular to the direction that the fine metal wires of the wire grid 252 extend. FIG. 7 schematically shows arrows representing the direction of the electrically poled axis.

The external mirror 22 in the present embodiment is formed of a VHG (volume holographic grating). When light incidents on the external mirror 22, it reflects the light having the fundamental wavelength, whereas transmitting the light having the converted wavelength. The external mirror 22 formed of a VHG has wavelength selectivity higher than that of an external mirror formed of a dielectric mirror and can reflect only the light having a specific wavelength.

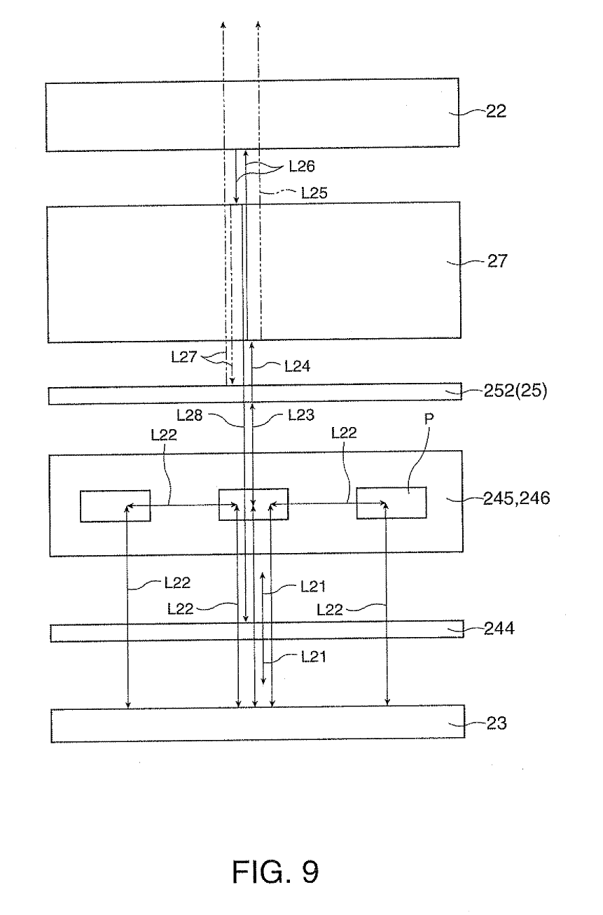

FIG. 9 is a descriptive diagram schematically showing the operation of the light source apparatus 2.

As shown in FIG. 9, part of light L21 generated by the MQW 244 and having the fundamental wavelength is diffracted by the diffractive optical layers 245, 246 and directed in the direction of 0° or 180° with reference to the light-exiting end surface and propagates back and forth multiple times in the diffractive optical layers 245, 246 in the direction parallel to the light-exiting end surface. Another part of the light L21 is diffracted by the diffractive optical layer 245, 246 and directed in the direction of 90° with reference to the light-exiting surface and propagates back and forth multiple times between the diffractive optical layers 245, 246 and the first electrode 23. The operation described above in the second embodiment is the same as that in the first embodiment, and the light resonates to the extent that no laser oscillation occurs.

Part of resonating light L22 having the fundamental wavelength is diffracted by the diffractive optical layers 245, 246 and directed in the directions of 90° with reference to the light-exiting end surface, and the resultant diffracted light L23 having exited from the diffractive optical layers 245, 246 is directed toward the wire grid 252 and the first electrode 23. Part of the diffracted light L23 that is directed vertically downward with respect to the light-exiting end surface is incident on the first electrode 23, whereas another part of the diffracted light L23 that is directed vertically upward direction with respect to the light-exiting end surface is incident on the wire grid 252 of the second electrode 25. When the light incidents on the wire grid 252, light L24 composed of a polarized light component whose electric field oscillates in the direction (X direction) perpendicular to the direction in which the fine metal wires extend (Y direction) passes through the wire grid 252 and reaches the wavelength conversion device 27.

Part of the light L24 incident on the wavelength conversion device 27 (infrared light having a wavelength of 1064 nm, for example) is converted into light L25 having the converted wavelength (green light having a wavelength of 532 nm, for example). Since the direction of the electrically poled axis (X direction) of the wavelength conversion device 27 coincides with the direction of the electric field of the light L24 oscillates (X direction), the wavelength of the light L24 can be efficiently converted into a wavelength substantially one-half the wavelength of the light L24. The resultant light L25 having the converted wavelength passes through the wavelength conversion device 27 along with the other part of the light L24, light L26 that has not undergone the wavelength conversion process and has the fundamental wavelength, and incidents on the external mirror 22.

When the light L25 and L26 incident on the external mirror 22, the light L25 having the converted wavelength passes through the external mirror 22 and exits out of the external mirror 22, whereas the light L26 having the fundamental wavelength is reflected back off the external mirror 22. The light L26 reflected by the external mirror 22 and having the fundamental wavelength is again incident on the wavelength conversion device 27, and part of the incident light is converted into light L27 having the converted wavelength. The light L27 having the converted wavelength is directed toward the wire grid 252 and reflected back off a wavelength selective reflection film (not shown) formed between the surface of the wire grid 252 and the wavelength conversion device 27. The wavelength selective reflection film is formed of a dielectric multilayer film or any other suitable film and characterized in that it transmits the light having the fundamental wavelength and reflects the light having the converted wavelength. The light L27 reflected by the wavelength selective reflection film is extracted out of the external mirror 22 along with the light L25. Light L28 that has not undergone the wavelength conversion process in the wavelength conversion device 27 and has the fundamental wavelength passes through the wire grid 252 and incidents on the diffractive optical layers 245, 246.

Due to the zeroth-order and second-order diffraction, part of the light L28 incident on the diffractive optical layers 245, 246 is coupled with the internally resonating light L22, as described in the first embodiment. The other part of the light L28, the light that has not been coupled with the light L22, and the light L23 diffracted by the diffractive optical layers 245, 246 and directed vertically downward, are reflected back off the first electrode 23 and incident on the diffractive optical layers 245, 246. Part of the light that has not coupled with the light L22 and the light diffracted by the diffractive optical layers 245, 246 and directed vertically upward incident the wire grid 252. Another part of the light has coupled with the zeroth-order and second-order diffracted light that have resonated in the internal cavity.

In this way, due to the diffraction, the light L22 having resonated in the process in which it propagates back and forth multiple times in the diffractive optical layers 245, 246 in the direction parallel to the light-exiting end surface couples with the light that propagates back and forth multiple times in the external resonant cavity formed between the first electrode 23 and the external mirror 22. As a result, the light L22 having resonated but achieved no laser oscillation only in the corresponding internal resonant cavity can be sufficiently amplified after it experiences the external resonance and returns to the internal resonant cavity. Laser oscillation thus occurs. Whenever the light having achieved laser oscillation and having the fundamental wavelength propagates back and forth in the corresponding resonant cavity and passes through the wavelength conversion device 27, part of the light having the fundamental wavelength is converted into the light having the converted wavelength. The light L25 and L27 having the converted wavelength pass through the external mirror 22 and exit out of the light source apparatus 2.

In the light source apparatus 2 according to the second embodiment, since the light emitter 21 emits substantially parallelized light as in the first embodiment, a thermal lens or any other collector lens is not necessary for achieving external resonance, allowing cost reduction. Further, since the wavelength conversion device 27 is disposed in the external resonant cavity, the strength of the electric field of specific wavelength at the position where the wavelength conversion device 27 exists can be extremely high. In general, the wavelength conversion efficiency of a nonlinear device such as PPLN can become high when increasing the strength of the electric field and the dimension in the periodic direction. In the light source apparatus 2, since the wavelength conversion device 27 is disposed in the resonant cavity that produces laser light having the fundamental wavelength and high electric field strength, the wavelength conversion efficiency of the wavelength conversion device 27 can be significantly high. Moreover, since the length of the external resonant cavity can not be restricted by other factors such as thermal lense, the dimension of the wavelength conversion device in the periodic direction can be increased, whereby the wavelength conversion efficiency of the wavelength conversion device 27 can be significantly high.

Further, since it is not necessary in the invention to prepare a thermal lens or control the temperature distribution in the semiconductor layer 24, the path of the current flowing through the semiconductor layer 24 is not be restricted. Therefore, the constraint on the shape of the second electrode 25 is relaxed, and a wire grid optical polarizer can be used as the second electrode 25, as in the second embodiment. As a result, the optical polarization state in the external resonant cavity can be controlled without a Brewster plate or any other suitable optical component for adjusting the optical polarization state, and the optical polarization state in the external resonant cavity can be set to coincide with the direction of the poled axis of the wavelength conversion device 27 even by using a simple configuration. That is, only specific polarization state of the light whose wavelength is converted at high efficiency in the wavelength conversion device 27 can achieve laser oscillation. It is therefore possible to convert the light having the fundamental wavelength into the light having converted wavelength at high efficiency and efficiently provide laser light having a wavelength that cannot be obtained directly from the light emitter.

Further, since the light emitter 21 emits substantially parallelized light, the optical path between the light emitter 21 and the external mirror 22 can be longer than that in a case where a collector lens or a thermal lens is used. It is therefore possible to increase the dimension of the wavelength conversion device 27 disposed between the light emitter 21 and the external mirror 22 in the optical path direction and significantly improve the wavelength conversion efficiency.

As described above, the light source apparatus 2 according to the second embodiment can provide high-intensity laser light having a desired wavelength at high efficiency.

Since the wavelength selective reflection film is disposed between the wavelength conversion device 27 and the light emitter 21, the light having the converted wavelength is not incident on the light emitter 21 but is reflected back off the wavelength selective reflection film. As a result, for example, the light having the converted wavelength will not be absorbed by the layers that form the light emitter 21 (such as the cladding layers and the guiding layers), and the light having the converted wavelength will be diffracted by the diffractive optical layers 245 and 246 and directed only in a desired direction, whereby the optical loss at the converted wavelength can be reduced.

The VHG used as the external mirror 22 in the second embodiment may be replaced with a dielectric mirror, as in the first embodiment. Conversely, the external mirror in the first embodiment can be formed of a VHG. Further, an FBG can be used as the external mirror in the both element, as will be described later.

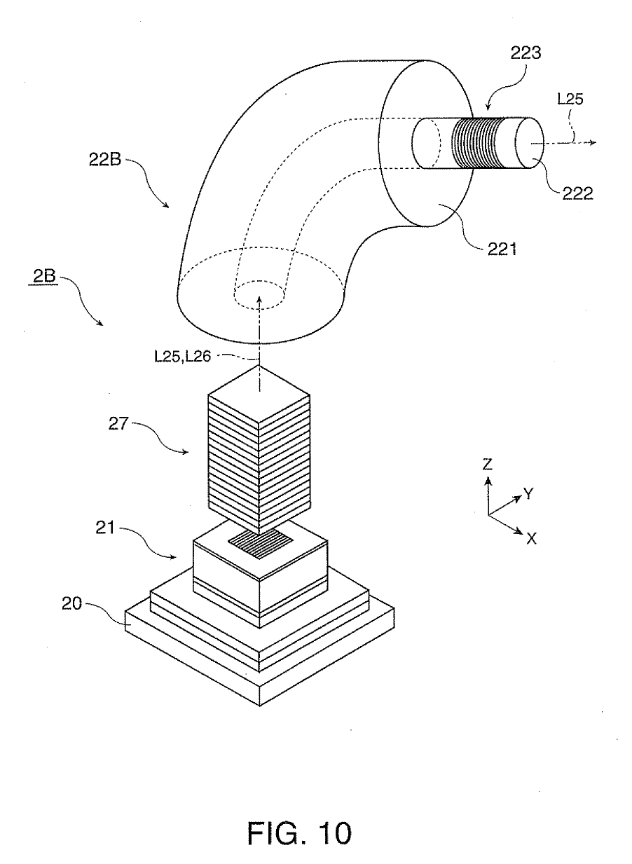

FIG. 10 is a perspective view showing a schematic configuration of a light source apparatus 2B according to Variation 1. As shown in FIG. 10, in the light source apparatus 2B, the external mirror in the light source apparatus 2 according to the second embodiment is replaced with an external mirror formed of an FBG 22B.

The FBG 22B is formed of what is called a fiber grating (sometimes referred to as a fiber Bragg grating). The FBG 22B is formed, for example, by using an optical fiber as a base material, thus includes a core 222 provided around the principal axis and a cladding 221 coated around the core 222. The core 222 has a grating 223, and the refractive index of the grating 223 periodically changes along with the direction of the principal axis.

When light incidents on the grating 223, the components whose wavelengths do not match the reflection band of the periodic structure of the grating 223 pass through the grating 223. On the other hand, the component whose wavelength matches the reflection band of the periodic structure of the grating 223 is reflected by the grating 223. In Variation 1, the periodic structure of the grating 223 is designed in such a way that the light having the fundamental wavelength is reflected.

In the thus configured light source apparatus 2B according to Variation 1, the light L25 and L26 outputted from the wavelength conversion device 27 enter the FBG 22B, pass through the core 222, and enter the grating 223. The light L25 incident on the grating 223 and having the converted wavelength passes through the grating 223 and exits out of the FBG 22. The light L26 incident on the grating 223 and having the fundamental wavelength is reflected back off the grating 223 and incident again on the wavelength conversion device 27. As a result, laser oscillation occurs and hence laser light having the converted wavelength is provided, as described in the second embodiment. Using the FBG 22B as the external mirror allows the direction of the output light extracted from the light source apparatus 2B to be readily controlled.

In the first and second embodiments, the first electrode is used as the reflective mirror that forms the corresponding resonant cavity, but a resonant mirror may alternatively be provided separately from the first electrode. The diffractive optical layer is made of a photonic crystal in the first and second embodiments but may alternatively be made of any material other than a photonic crystal as long as the material diffracts the light having the fundamental wavelength in a desired direction. Further, the diffractive optical layer may be formed of a single layer or multiple layers as long as one or more layers are designed to diffract the light having the fundamental wavelength. Moreover, the diffractive optical layer may be formed in a single layer or multiple layers and the position thereof may be lower than that of the active layer. Further, the diffractive optical layer may be designed in such a way that light is emitted from the light emitter in a direction inclined to the light-exiting end surface. Variations of the diffractive optical layer will be described below.

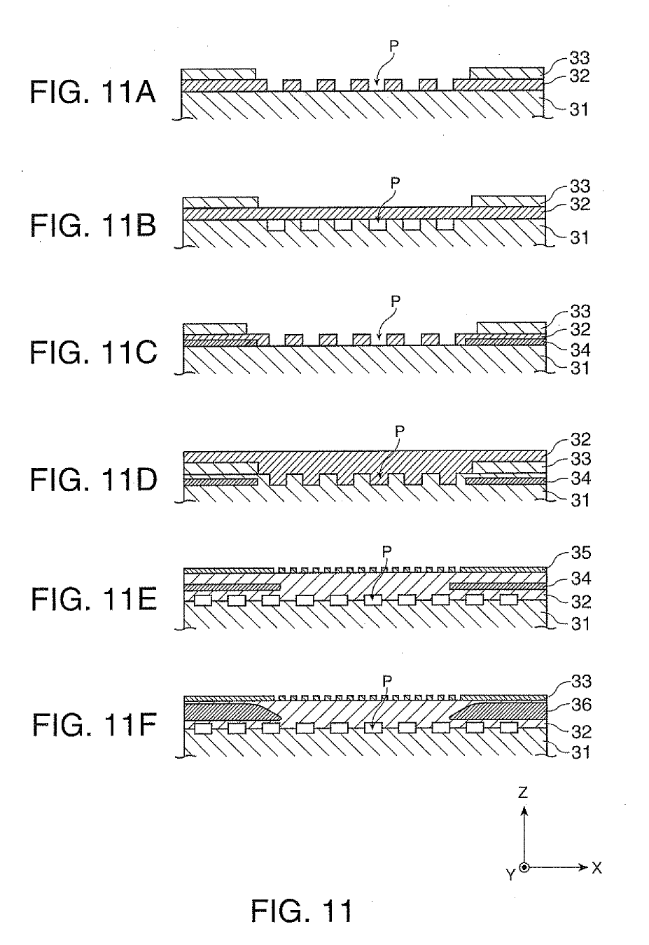

FIGS. 11A to 11F are cross-sectional views showing a key portion of the diffractive optical layer according to Variations.

The diffractive optical layer according to Variation 2 shown in FIG. 11A is formed in a p-cladding layer 32, which is a single layer. The p-cladding layer 32 is the same as the p-cladding layer in the first and second embodiments and provided on a second guiding layer 31. Through holes are provided in the p-cladding layer 32, and the through holes function as the lattice points P. A second electrode 33, which is the same as that in the first embodiment, is provided on the p-cladding layer and the lattice points P are exposed through the second electrode 33.

The through holes may be filled with a filling material whose refractive index differs from that of the p-cladding layer 32. The filling material may cover the second electrode 33 and the p-cladding layer 32 surrounded by the second electrode 33. The thus formed filling material can function as a protective film that protects the second electrode 33 and the p-cladding layer 32 from moisture, oxidization, mechanical damage, and so on. Examples of the filling material include oxides and nitrides of silicon, titanium, tantalum, and other elements, specifically, SiO₂, SiON, SiN, TiO₂, TiN, Ta₂O₃, Ta₂O₅, and other compounds.

The diffractive optical layer according to Variation 3 shown in FIG. 11B is formed in the second guiding layer 31, which is a single layer. Recesses are formed in the surface of the second guiding layer 31, and the recesses function as the lattice points P. The p-cladding layer 32 is provided to cover the second guiding layer 31, and the second electrode 33 is provided on the p-cladding layer 32.

The diffractive optical layer according to Variation 4 shown in FIG. 11C is similar to that according to Variation 2 shown in FIG. 11A. Variation 4 differs from Variation 2 in that an oxide aperture (current constriction region) 34 is provided in a partial planar area between the second guiding layer 31 and the p-cladding layer 32. The oxide aperture 34 is obtained, for example, by oxidizing AlₓGa₍₁₋ₓ₎As (x>0.95). To form the oxide aperture 34, for example, a layer made of AlₓGa₍₁₋ₓ₎As (x>0.95) or any other suitable material is first formed on the second guiding layer 31 before the p-cladding layer 32 is formed. The side surface of the AlₓGa₍₁₋ₓ₎As layer on the same side of the outer side of the diffractive optical layer is then exposed by using photolithography technique and etching technique or any other suitable technique. The resultant structure is then placed in a steam atmosphere at a temperature ranging from approximately 350 to 500° C. In this way, the AlₓGa₍₁₋ₓ₎As (x>0.95) layer is oxidized from the side surface, and the oxidized portion forms the oxide aperture.

In the portion where the oxide aperture 34 is formed, carriers do not move across the oxidized space between the second guiding layer 31 and the p-cladding layer 32 in the thickness direction of the oxide aperture 34. As a result, the carriers move between the second guiding layer 31 and the p-cladding layer 32 selectively across the portion where oxide aperture 34 is not formed, whereby the density of the carriers supplied into the active layer (see FIGS. 2A and 2B) can be increased. It is therefore possible to define the current injection area of the active layer from which light is emitted and efficiently produce high-intensity light from the active layer.

The diffractive optical layer according to Variation 5 shown in FIG. 11D is similar to that according to Variation 3 shown in FIG. 11B. Variation 5 differs from Variation 3 in that the second electrode 33 abuts the second guiding layer 31 and part of the p-cladding layer 32 is buried in recesses provided in the second guiding layer 31. The p-cladding layer 32 described above can be formed in a regrowth process after the second electrode 33 is formed. Providing the second electrode in such a way that it abuts the second guiding layer 31 allows the resistance and hence the heat generation to decrease.

The diffractive optical layer according to Variation 6 shown in FIG. 11E is similar to the diffractive optical layer according to the second embodiment shown in FIG. 8, but differs therefrom in that the oxide aperture 34 is provided in the p-cladding layer 32.

The diffractive optical layer according to Variation 7 shown in FIG. 11F is similar to that according to Variation 6 shown in FIG. 11E but differs therefrom in that the oxide aperture 34 is replaced with a current constriction region 36 into which protons (hydrogen ions) are implanted.

As described above, since the light emitter does not need to have a thermal lens function in the invention, the distance from the active layer (MQW) to the light-exiting end surface can be smaller than that in a case where a thermal lens is used, as in Variations 2 to 7. As a result, the electric resistance can be reduced, whereby the power consumption can be reduced and the temperature characteristics can be improved. Further, since the constraint on the path along which the carriers move from the second electrode to the active layer is relaxed. As compared with the case where a thermal lens is used, the constraint on the position where the current constriction region is formed is relaxed. It is therefore possible to form the current constriction region in such a way that the carriers are injected only into a desired region in the active layer, whereby the active layer can efficiently produce high-intensity light.

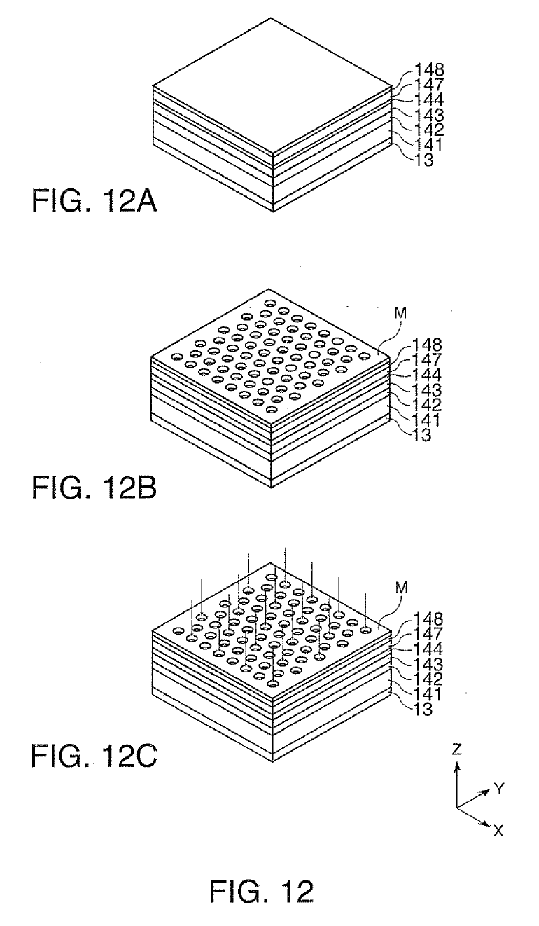

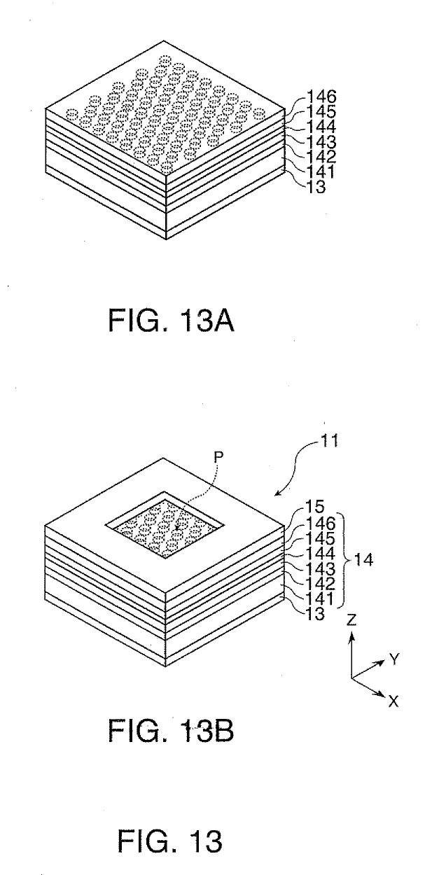

An exemplary method for manufacturing a light source apparatus will be schematically described based on the configuration of the first embodiment. FIGS. 12A to 12C and FIGS. 13A and 13B are process diagrams showing a method for forming a light emitter.

As shown in FIG. 12A, the n-cladding layer 142, the first guiding layer 143, and the MQW 144 are first formed in this order on the semiconductor substrate 141. A first material layer 147, which will be the second guide 145 later, and a second material layer 148, which will be part of the p-cladding layer 146 later, are then formed in this order on the MQW 144. The first electrode 13 is then formed on the bottom side of the semiconductor substrate 141. The first electrode 13 may be formed later. Known methods and materials can be used to form the layers that form the semiconductor layer 14.

A mask pattern M is then formed on the second material layer 148, as shown in FIG. 12B. Although the structure of the mask pattern M is not shown in detail, the mask pattern M is provided substantially all over the second material layer 148. The mask pattern M is formed of a hard mask layer made of a silicon oxide, a silicon nitride, or any other suitable material and a resist pattern provided on the hard mask layer. The resist pattern is formed by coating a resist material substantially all over the hard mask layer to form a resist film and then patterning the film using spin coater in an EB drawing process using an electron beam lithography technique or interference lithography technique (desirably carried out by a liquid immersion lithography). The resist pattern may alternatively formed by patterning a resist film by using a nanoimprint lithography or any other suitable technique.

The resist pattern is used as a mask to etch and pattern the hard mask layer, as shown in FIG. 12C. The patterned hard mask layer is then used as a mask to etch the first material layer 147 and the second material layer 148. Through holes are thus formed in the portions in the second material layer 148 where the lattice points P are formed. The through holes become the recesses 146a shown in FIGS. 2A and 2B later. Similarly, the recesses 145a shown in FIGS. 2A and 2B are formed in the portions in the first material layer 147 where the lattice points P are formed. The first material film having formed the recesses 145a therein forms the second guiding layer 145.

After the mask pattern M is removed, the thickness of the patterned second material layer 148 is increased to form the p-cladding layer 146, as shown in FIG. 13A. To increase the thickness, for example, a thin plate made of a semiconductor material is fused onto the second material film, or the second material film undergoes regrowing process. Known wafer fusion techniques include fusing an indium phosphide layer with a silicon layer, fusing an indium phosphide layer with a gallium arsenide layer, fusing a gallium arsenide layer with a gallium nitride layer, fusing a gallium arsenide layer with another gallium arsenide layer, fusing an indium phosphide layer with another indium phosphide layer, fusing an indium gallium arsenide layer with a silicon layer, and other fusing techniques for a variety of materials. A technique appropriately selected from the known wafer fusion techniques may be used.

It is noted that atoms may be migrated between two layers to be fused in a fusion process and the shape of the recesses, which form the lattices, and the shape of the through holes before the fusion process may differ from those after the fusion process. Designing the recesses and the through holes in consideration of such a change in shape allows the characteristics of the diffractive optical layer to be precisely controlled.

The second electrode 15 is then formed on the p-cladding layer 146. The first electrode 13 may be formed on the bottom side of the semiconductor substrate 13 at this point. In this case, the order of forming first and second electrodes 13 and 15 is not limited. The light emitter 11 is thus provided, as shown in FIG. 13B. The light emitter 11 is then attached to the heat sink 10 and the external mirror 12 and other components are disposed. The light source apparatus 1 shown in FIG. 1 is thus provided.

The current constriction region can also be formed by using ion implantation or any other suitable method at an appropriately selected timing after the first material layer is formed but preferably before the first and second electrodes are formed.

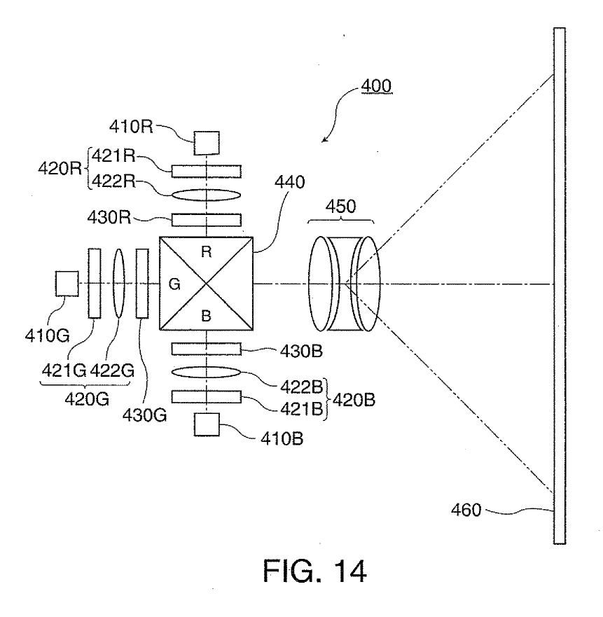

A projector according to an embodiment of the invention will be described. FIG. 14 is a schematic configuration diagram showing a projector 400 according to the present embodiment. As shown in FIG. 14, the projector 400 includes laser light source apparatus (light source apparatus) 410R, 410G, and 410B, transmissive liquid crystal light valves (modulators) 430R, 430G, and 430B, a dichroic prism 440, and a projection system (display system) 450. The laser light source apparatus 410R, 410G, and 410B emit red, green, and blue light beams, respectively, and the emitted color light beams are modulated by the respective liquid crystal light valves 430R, 430G, and 430B. The modulated color light beams are combined in the dichroic prism 440, and the combined light is projected through the projection system 450.

The projector 400 according to the present embodiment further includes homogenizing systems 420R, 420G, and 420B that make the intensity distributions of the laser light beams emitted from the laser light source apparatus 410R, 410G, and 410B uniform. The liquid crystal light valves 430R, 430G, and 430B are thus illuminated with light beams having uniform intensity distributions. The homogenizing system 420R includes a hologram 421R and a field lens 422R, and the homogenizing systems 420G and 420B are configured in the same manner.

The color light beams modulated by the liquid crystal light valves 430R, 430G, and 430B are incident on the dichroic prism 440. The dichroic prism 440 is formed by bonding four rectangular prisms and thus has internal surfaces that intersect each other. One of the internal surfaces has a dielectric multilayer film that reflects red light, and the other internal surface has a dielectric multilayer film that reflects blue light. The three color light beams are combined at the dielectric multilayer films into light carrying a color image. The combined light is enlarged and projected through the projection system 450 onto a screen 460. A projection image is thus displayed.

In the projector 400 according to the present embodiment, since at least one of the laser light source apparatuses 410R, 410G, and 410B is formed of the light source apparatus according to an embodiment of the invention, an image provided by the projector has a large dynamic range and high quality. Further, since at least one of the laser light source apparatus 410R, 410G, and 410B emits narrow-band laser light, the projector shows satisfactory high color reproducibility.

In the above description, transmissive liquid crystal light valves are used as the modulators. Alternatively, reflective liquid crystal light valves, spatial modulators using digital mirror devices (DMDs), or other devices may be used. The configuration of the projection system may be changed appropriately in accordance with the type of modulators to be used. The cross dichroic prism is used as a light combining device in the above description. The light combining device may alternatively be, for example, dichroic mirrors disposed in parallel to one another so that color light beams are combined, or a prism that receives a plurality of color light beams incident in different directions and combines the color light beams by using aberrations.

The invention is also applicable to a scanning-type projector. A scanning-type projector may uses, for example, a modulation circuit (modulator) to adjust the output of a light source apparatus so that the light source apparatus emits light whose grayscale changes with time in accordance with an image signal and a scanning system (display system) to scan the light across a display area.

The light source apparatus according to an embodiment of the invention can also be used, for example, as an illuminator of a laser machining apparatus and an imaging apparatus as well as a projector.

The entire disclosure of Japanese Patent Application No. 2009-64366, filed Mar. 17, 2009 is expressly incorporated by reference herein.

What is claimed is:

1. A light source apparatus comprising:
a light emitter;
a pair of electrodes for driving the light emitter; and
an external resonant cavity that reflects part of the light emitted from a light-exiting end surface of the light emitter,
wherein the light emitter includes
an active layer that generates light,
an internal resonant cavity, and
a diffractive optical layer that diffracts light having a predetermined wavelength,
the external resonant cavity includes an external mirror that reflects the light having the predetermined wavelength, and
the internal resonant cavity, the external resonant cavity, and the diffractive optical layer form a laser resonant cavity that allows the light emitted from the active layer to achieve laser oscillation.

2. The light source apparatus according to claim 1,
wherein the diffractive optical layer is made of a photonic crystal or a quasi-photonic crystal.

3. The light source apparatus according to claim 1,
wherein the diffractive optical layer diffracts part of the light having the predetermined wavelength in such a way that the part of the light having the predetermined wavelength is incident on the reflection surface of the external mirror in the direction of a normal thereto.

4. The light source apparatus according to claim 1,
wherein the reflection surface of the external mirror is substantially parallel to the light-exiting end surface, and the diffractive optical layer diffracts part of the light having the predetermined wavelength in the direction perpendicular to the light-exiting end surface.

5. The light source apparatus according to claim 1,
wherein the diffractive optical layer diffracts part of the light having the predetermined wavelength in the direction parallel to the light-exiting end surface.

6. The light source apparatus according to claim 1,
wherein the external mirror is formed of a volume holographic grating.

7. The light source apparatus according to claim 1,
wherein the external mirror is formed of a fiber grating.

8. The light source apparatus according to claim 1,
wherein the light emitter has a current constriction region that limits an area across which carriers are injected from the pair of electrodes in a in-plane direction parallel to the active layer.

9. The light source apparatus according to claim 1,
wherein the light emitter includes a heat spreading member on the side opposite to the light-exiting end surface.

10. The light source apparatus according to claim 1,
further comprising a wavelength conversion device in the optical path between the light emitter and the external resonant cavity.

11. The light source apparatus according to claim 10,
wherein the wavelength conversion device has a periodically poled structure.

12. The light source apparatus according to claim 1,
further comprising a wire grid optical polarizer in the optical path between the light emitter and the external mirror, the wire grid optical polarizer carrying out an optical polarization separation process in which the light emitted from the light emitter is separated based on optical polarization,
wherein the wire grid optical polarizer is provided monolithically with the light emitter.

13. The light source apparatus according to claim 12,
further comprising a wavelength conversion device in the optical path between the light emitter and the external resonant cavity.

14. The light source apparatus according to claim 13,
wherein the wavelength conversion device has a periodically poled structure.

15. The light source apparatus according to claim 14,
wherein the polarization direction of the light separated by the wire grid optical polarizer and incident on the wavelength conversion device is substantially parallel to the direction of the electrically polarized axis of the wavelength conversion device.

16. The light source apparatus according to claim 12,
wherein one of the pair of electrodes is formed of the wire grid optical polarizer.

17. A projector comprising:
the light source apparatus according to claim 1;
a modulator that modulates the light emitted from the light source apparatus; and
a display system that displays the light modulated by the modulator.
